(19) United States
(12) Patent Application Publication
(10) Pub. No.: US 2007/0048869 A1
(43) Pub. Date: Mar. 1, 2007

(54) Valve system and deposition apparatus including valve system and atomic layer deposition chamber

(76) Inventors: Beung-Keun Lee, Hwaseong-si (KR); Sang-Cheon Baek, Yongin-si (KR); Hyoun-Cheol Kim, Hwaseong-si (KR); Hwan-Suk Ju, Hwaseong-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/507,452

(22) Filed: Aug. 22, 2006

(30) Foreign Application Priority Data
Aug. 24, 2005 (KR) 2005-77928

(51) Int. Cl. G01N 35/08; B05B 7/06

(52) U.S. Cl. 436/55; 118/314

(57) ABSTRACT

A deposition apparatus includes an Atomic Layer Deposition (ALD) chamber, a system-control unit which generates a control signal, a solenoid valve which supplies air pressure in response to the control signal generated by the system-control unit, a gas line which supplies a process gas, an air pressure valve which opens and closes in response to the air pressure supplied by the solenoid valve to selectively supply the process gas from the gas line for the ALD chamber, and a detection unit installed in the air pressure valve which generates a detection signal indicative of at least one of an opened and closed state of the air pressure valve. The detection signal generated from the detection unit is transmitted to the system control unit, and the system control unit compares a calculated open duration of the air pressure valve with an actual open duration of the air pressure valve.

### BACKGROUND OF THE INVENTION

1. Field of the Invention

The present invention relates generally to the fabrication of semiconductor devices, and more particularly, the present invention relates to an air pressure valve system of an atomic layer deposition (ALD) chamber.

A claim of priority is made under 35 USC § 119 to Korean Patent Application No. 2005-77928, filed on Aug. 24, 2005, in the Korean Intellectual Property Office, the entirety of which is incorporated herein by reference.

2. Description of the Related Art

In semiconductor device manufacturing, a thin layer formation process is typically carried out in a low-pressure chemical vapor deposition (“LPCVD”) chamber. In chemical vapor deposition (“CVD”), a wafer or a semiconductor substrate is loaded into a process chamber, and a reaction gas is then introduced into the process chamber under suitable conditions to form a thin layer on the wafer or semiconductor substrate.

A variety of different types of CVD processes are known, including atomic layer deposition (“ALD”), atomic layer chemical vapor deposition (“ALCVD”), and so on.

In ALD, different reactive precursors are alternately introduced into the process chamber so as to be chemisorbed on a semiconductor substrate to form respective layers on the semiconductor substrate. Each time one of the reactive precursors is introduced, a new atomic layer of uniform thickness is formed on a previously formed atomic layer. The reactive precursors are alternately introduced for relatively short durations a given number of cycles to obtain a desired layer thickness. In addition, an inert gas may be introduced into the chamber prior to each introduction of reactive precursors.

Each cycle of the ALD process typically involves the opening and closing of one or several valves to control the flow of process gases and purge gases into the process chamber. Among these valves, an air-pressure-actuated gas valve (hereinafter, an “air pressure valve”) is used to alternate the flow of different process and purge gases into the process chamber. The air pressure valve is driven by air pressure under control of an electrical valve such as, for example, a solenoid valve having an electromagnet that is magnetized when a current is supplied to the electromagnet. The air pressure valve is opened or closed to control the flow of gas into the process chamber.

FIG. 1 is a block diagram illustrating a conventional air pressure valve system 10 for an ALD process chamber 26. As shown, the conventional air pressure valve system 10 includes an air-supply unit 12, a solenoid valve 16, a system-control unit 18, an air pressure valve 20, and a gas supply unit 22.

The solenoid valve 16 is an electrical valve driven by a control signal 28 of a system control unit 18. The solenoid valve 16 opens or closes an air line between the air-supply unit 12 and the air pressure valve 20. In this manner, the solenoid valve 16 allows for air flow from the air-supply unit 12 into the air pressure valve 20 or blocks the flow of air from the air-supply unit 12 into the air pressure valve 20.

The air pressure valve 20 is installed in a gas line 24 for supplying a gas into the process chamber 26 from the gas-supply unit 22. Further, the air pressure valve 20 is opened or closed by action of air pressure established through the air line 14 under control of the solenoid valve 16. In this manner, the solenoid valve 16 indirectly controls the flow of gas into the process chamber 26.

The conventional air pressure valve system 10 has several shortcomings. For example, if the solenoid valve 16 is worn out over a period of time or includes one or more defective parts, air may be continuously supplied into the air pressure valve 20. This continuous supply of air can cause the air pressure valve 20 to stay open for an excessively long period of time, resulting in excess gas flow (or leakage) through the gas line 24. If the gas is flammable and/or toxic, such leakage may lead to accidents during the ALD process.

On the other hand, air may leak from the air line 14, thus reducing the air pressure supplied to the air pressure valve 20. This reduction in air pressure can cause malfunctions in the air pressure valve 20 which result in an insufficient supply of gas into the process chamber 26. This.can lead to device failures in the semiconductor device fabrication process.

In addition, the conventional air pressure valve system 10 uses an interlock management scheme to determine whether or not the air pressure valve 20 is open. Interlock management of the air pressure valve 20 relies on the monitoring of certain process parameters to indirectly determine whether the air pressure valve 20 is in an opened or closed state. Examples of such parameters include the inner pressure of the process chamber 26, the flow rates of the gases, and so on.

However, particularly in ALD processing, it is difficult to accurately determine whether the air pressure valve 20 is opened or closed based upon indirect reliance of process parameters. This is because, as explained above, ALD processing includes alternating introduction of process and inert gases for relatively short periods of time. That is, in ALD processing, the air value 20 is open for relatively short durations, making it difficult to accurately detect an open valve state. This can lead to malfunctions which, as mentioned above, can cause accidents and/or device failures during ALD processing.

### SUMMARY OF THE INVENTION

According to one aspect of the present invention, a valve system is provided which includes a system-control unit which generates a control signal, a solenoid valve which supplies air pressure in response to the control signal generated by the system-control unit, a gas line which supplies a process gas an air pressure valve which opens and closes in response to the air pressure supplied by the solenoid valve to selectively supply the process gas from the gas line, and a detection unit installed in the air pressure valve which generates a detection signal indicative of at least one of an opened and closed state of the air pressure valve. The detection signal generated from the detection unit is transmitted to the system control unit, and the system control unit compares a calculated open duration of the air pressure valve in accordance with the control signal with an actual open duration of the air pressure valve in accordance with the detection signal.

According to another aspect of the present invention, a deposition apparatus is provided which includes an Atomic Layer Deposition (ALD) chamber, a system-control unit which generates a control signal, a solenoid valve which supplies air pressure in response to the control signal generated by the system-control unit, a gas line which supplies a process gas, an air pressure valve which opens and closes in response to the air pressure supplied by the solenoid valve to selectively supply the process gas from the gas line for the ALD chamber, and a detection unit installed in the air pressure valve which generates a detection signal indicative of at least one of an opened and closed state of the air pressure valve. The detection signal generated from the detection unit is transmitted to the system control unit, and the system control unit compares a calculated open duration of the air pressure valve in accordance with the control signal with an actual open duration of the air pressure valve in accordance with the detection signal.

### BRIEF DESCRIPTION OF THE DRAWINGS

The above and other features and advantages of the invention will become readily apparent by reference to the following detailed description when considered in conjunction with the accompanying drawings wherein:

FIG. 1 is a block diagram illustrating a conventional air pressure valve system of an ALD chamber;

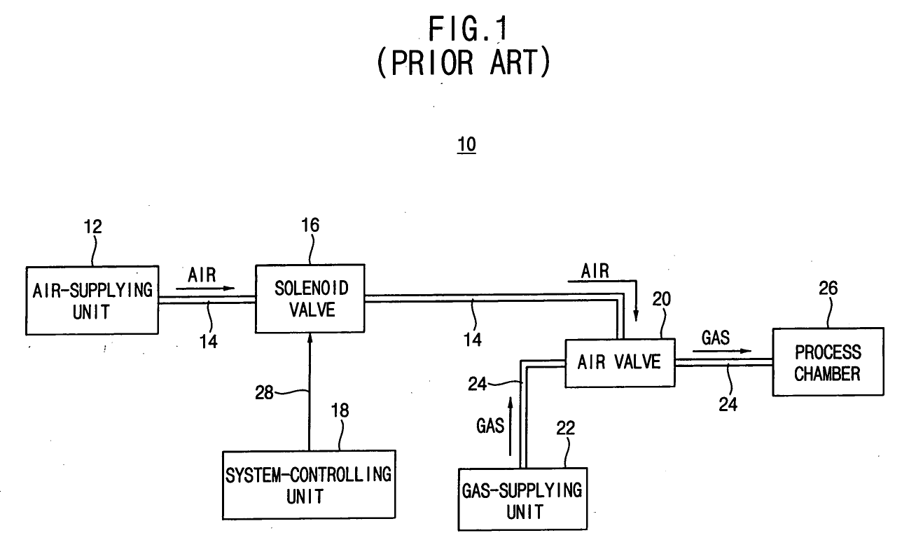

FIG. 2 is a block diagram illustrating an air pressure valve system of an ALD chamber according to an exemplary disclosed embodiment;

FIG. 3 is a cross-sectional view of the air pressure valve in FIG. 2 according to an exemplary disclosed embodiment;

FIG. 4 is a graph illustrating a control signal and a detection signal in the air pressure valve system in FIG. 2 according to an exemplary disclosed embodiment; and

FIG. 5 is a flow chart illustrating operations for controlling valves in an ALD process according to an exemplary disclosed embodiment.

### DESCRIPTION OF THE EMBODIMENTS

The present invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected, or coupled to the other element or layer, or in the alternative, intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

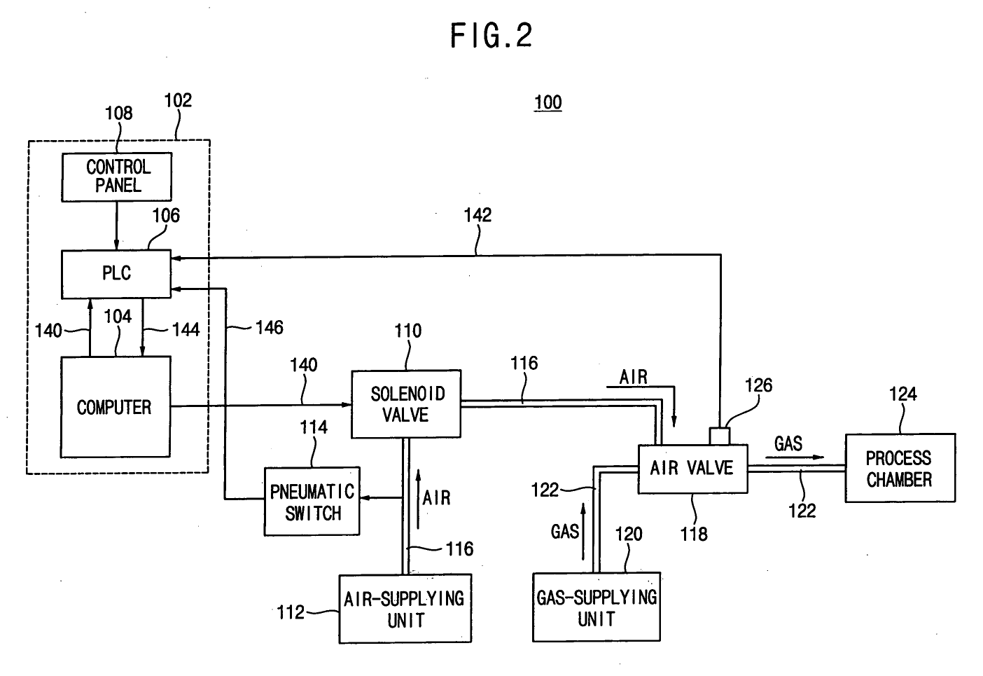

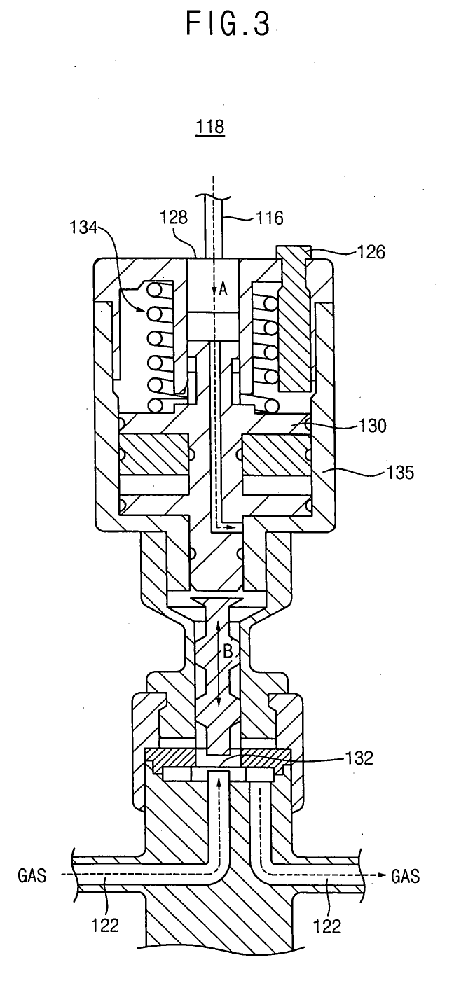

FIG. 2 is a block diagram of an air pressure valve system of an ALD chamber in accordance with an embodiment of the present invention, and FIG. 3 is a cross-sectional view illustrating the air pressure valve in FIG. 2 according to an embodiment of the present invention.

Referring to FIG. 2, an air pressure valve system 100 includes a plurality of air pressure valves 118 connected to a process chamber 124 in which an ALD process is carried out, a solenoid valve 110 which supplies air into the air pressure valves 118 through air lines 116 from an air supply unit 112, and a system control unit 102 for outputting a control signal to the solenoid valve 110 to control the solenoid valve 110. The air pressure valve system 100 may also include a plurality of gas supply units 120.

The solenoid valve 110 may include an electrical valve. Specifically, the solenoid valve 110 may include an electromagnet in the form of a drive coil. The drive coil may be converted into a strong magnet when a current flows through the drive coil. The resulting magnetic force may be used to operate the solenoid valve 110 to supply air to the plurality of air pressure valves 118. Thus, the solenoid valve 110 converts an electrical signal into a mechanical signal. In an exemplary embodiment, the solenoid valve 110 converts the control signal of the system control unit 102 into a mechanical signal. The solenoid valve 110 may include a plurality of ports connected to the air pressure valves 118 through the air lines 116. Specifically, the solenoid valve 110 may open or close the air lines 116 to allow the air flow into the air pressure valves 118 or block the air flow into the air pressure valves 118.

The plurality of air pressure valves 118 may be connected to the plurality of gas supply units 120. Specifically, each of the air pressure valves 118 may be connected to each of the gas supply units 120 through each of the gas lines 122, respectively. The gas supply units 120 may be configured to supply at least two types of gases (e.g., process gases and purge gases.)

Referring to FIG. 3, each of the air pressure valves 118 includes a sealed space 135. The sealed space 135 may be connected to the gas line 122. The air pressure valve 118 may also include an air inlet 128, an actuator 130, and a diaphragm 132. The actuator 130 may be configured to move vertically in the sealed space 135. The diaphragm 132 may be configured to allow the gas to flow through the gas line 122 or to block the gas flow through the gas line 122 in accordance with the vertical movement of the actuator 130.

The air pressure valve 118 may also include a detection unit 126 mounted on the actuator 130. The detection unit 126 may, based on the positions of the actuator 130, detect whether the air pressure valve is open or not. The detection unit may also generate a detection signal based on the position of the actuator 130. The detection unit 126 may also convert the detection signal into an electrical signal 142. The electrical signal 142 may be transmitted to the system control unit 102.

In an exemplary embodiment, the detection unit 126 may include a micro switch, a photo-proximity sensor, or any other device that may detect a position of the actuator 132 and transmit the position information to system control unit 102.

System controlling unit 102 may include a computer 104, a programmable logic controller (“PLC”) 106, and a control panel 108. The PLC 106 may be electrically connected to computer 104. The system controlling unit 102 may be configured to control the operation of air pressure valve 118 through solenoid valve 110. For example, when the system control unit 102 transmits an “OFF” signal to the solenoid valve 110, the solenoid valve 110 may block the air flow into the air pressure valve 118. The air pressure valve 118 is then closed. Closure of the air pressure valve 118 may cause a spring in the sealed space 135 to expand. The expansion of the spring may cause the actuator 130 to descend towards diaphragm 132. The descended actuator 130 may compress the diaphragm 132, thereby blocking the gas line 122 that is connected to the air pressure valve 118. At this time, the detection unit 126 may generate a detection signal to indicate the closure of the air pressure valve 118. Furthermore, the detection unit 126 may convert the detection signal into an electrical signal 142 and transmit the electrical signal 142 to the system control unit 102.

When the system control unit 102 transmits an “ON” signal to the solenoid valve 110, the solenoid valve 110 allows the air flow into the air pressure valve 118. The air pressure valve 118 is then open. At this time, the air flows into the sealed space 135 through the air inlet 128. This air flow may cause the actuator 130 to ascend due to an induced air pressure. The ascension of actuator 130 may cause compressed diaphragm 132 to regain its original state. As a result, an inlet and an outlet of the gas line 122 connected to the air pressure valve 118 may open so that the gas flows into the process chamber 124 through the gas line 122. At this time, the detection unit 126 may detect the opened state of the air pressure valve 118 to generate a detection signal. The detection unit 126 may also convert the detection signal indicating the opened state of the air pressure valve 118 into an electrical signal 142 and transmit the electrical signal 142 to the system control unit 102.

In FIG. 3, “A” represents a direction of air flow of the air introduced into the air pressure valve 118. “B” indicates a direction of movement of the actuator 130 in air pressure valve 118.

In an exemplary embodiment, the system control unit 102 may be configured to receive the detection signal 142 from the detection unit 126. In addition, the system control unit 102 may be configured to send a control signal 140 to the solenoid valve 110. As described above, the control signal 140 may be used to control the operation (i.e., opening and closing) of the solenoid valve 110. The system control unit 102 may also be configured to compare an actual duration for which the air pressure valve 118 is open or closed with a calculated duration for which the air pressure valve 118 should have been open or closed. This comparison may be based on the detection signal 142 obtained from the detection unit 126 and the control signal 140 sent to the solenoid valve 110. When an actual open duration of the air pressure valve 118 is beyond a predetermined reference value, the system control unit 102 may generate a warning signal and suspend operations of at least some parts of the air pressure valve system 100.

Specifically, the computer 104 in system control unit 102 may be configured to output the control signal 140 to the solenoid valve 110. Furthermore, the PLC 106 and the solenoid valve 110 may simultaneously receive the control signal 140 from the system control unit 102. In addition to receiving the control signal 140 from the system control unit 102, the PLC 106 may also receive the detection signal unit 142 from the detection unit 126.

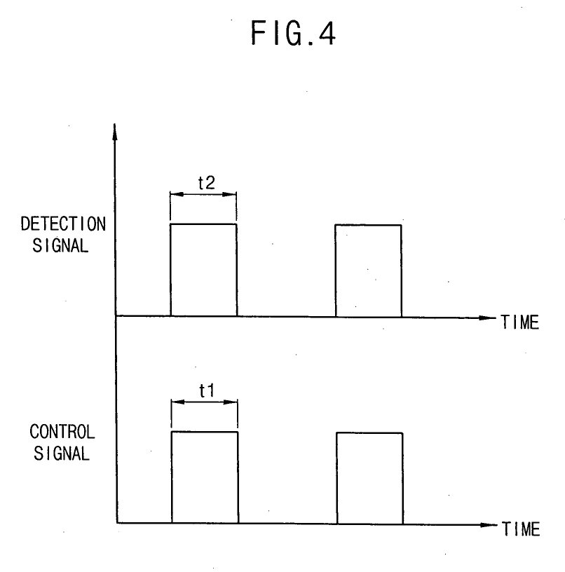

FIG. 4 is a graph illustrating the control signal 140 outputted to the solenoid valve 110 and the detection signal 142 inputted from the detection unit 126 in FIG. 2.

Referring to FIG. 4, t1 refers to the calculated duration for which the air pressure valve 118 should be open. This calculated open duration may be determined in accordance with the control signal 140 outputted to the solenoid valve 110 from the computer 104. This determination may be based on theoretical calculations which may map a given control signal 140 to a given calculated open duration t1. For example a control signal of 3V may correspond to a calculated duration of 1s. These theoretical calculations may be based on the ratings of the solenoid valve 110, air supply unit 116, and air pressure valve 118. Alternatively, the mappings may be based on experimental results. In addition, any other calculation method may be used to determine the calculated duration t1.

T2 refers to the actual duration for which the airpressure valve 118 is open. This actual open duration may be determined in accordance with the detection signal 142 inputted into the PLC 106 from the detection unit 126. A difference At between the calculated open duration t1 and the actual open duration t2 may be required to be within an allowable error range so as to normally operate the air pressure valve 118.

In an exemplary embodiment, the PLC 106 may compare the calculated open duration t1 of the air pressure valve 118 in accordance with the control signal 140 with the actual open duration t2 of the air pressure valve 118 in accordance with the detection signal in real time. When the difference At between the calculated open duration t1 and the actual open duration t2 is beyond the allowable error range, the PLC 106 may transmit a warning signal to the computer 104.

The allowable error range may be stored as a reference value in the system-controlling 102. In an exemplary embodiment, the reference value may be stored in a control panel 108. The control panel 108 may be electrically connected to the PLC 106. One skilled in the art will appreciate that control panel 106 may be configured as any input/output device. For example, control panel 108 may include a touch type panel. In an alternative exemplary embodiment, the reference value may be directly inputted into the PLC 106 or the computer 104 without using the control panel 108.

The computer 104 may include any computing device capable of running a program. For example, the computer 104 may include a personal computer, in which a program for controlling operations of the process chamber 124 is stored. These operations may include, for example, controlling the temperature inside the process chamber 124, controlling an elevation of a wafer in the process chamber 124, and controlling the flow of process gas and purge gas into and out of the process chamber 124. In addition, any other operation of the process chamber 124 may be controlled by the program in the computer 104. The process chamber 124 may include hardware such as, for example, a heater, elevator, pump and one or more valves that may be controlled by computer 104.

In an exemplary embodiment, when the process chamber 124 is ready to perform the ALD process, the computer 104 outputs the control signal 140 to the solenoid valve 110. The control signal 140 may be used to open or close the solenoid valve 110. Furthermore, the computer 104 may also transmit the control signal 140 to the PLC 106.

The air supply may be either allowed or blocked into the air line 116 in accordance with the control signal 140. This allowance or blockage of the air supply may cause the air pressure valve 118 to be opened or closed. The opening and closing of the air pressure valve 118 may cause the semiconductor substrate in the process chamber 124 to be selectively exposed to the gas flow through the gas line 122.

The detection unit 126 on the air pressure valve 118 may be used to determine an open or closed state of the air pressure valve 118 based on the positions of the actuator 130. In addition, the detection unit 126 may generate a detection signal indicating the open or closed state of the air pressure valve 118. Furthermore, the detection unit 126 may convert the detection signal, which may be in the form of a mechanical signal, into the electrical signal 142. The detection unit 126 may transmit the electrical signal 142 to the PLC 106. The PLC 106 may compare the calculated open duration t1 of the air pressure valve 118 based on the control signal 140 inputted from the computer 104 with the actual open duration t2 of the air pressure valve 118 based on the electrical signal 142 inputted from the detection unit 126. When the actual open duration t2 of the air pressure valve 118 differs from the calculated open duration t1 by an amount greater than the reference value, the PLC 106 may output the warning signal 144 to the computer 104.

The computer 104 may receive the warning signal 144. Based on the warning signal 144 received, the computer 104 may transmit stop signals to immediately pause operations of certain parts in the air pressure valve system 100. For example, if the actual open duration t2 is greater than the calculated open duration t1 by an amount greater than the reference value, then computer 104 may transmit a stop signal to pause the operation of a driver of the gas line 122.

In an exemplary embodiment, a pneumatic switch 114 is installed in the air line 116 between the air supply unit 112 and the solenoid valve 110. The pneumatic switch 114 may sense the air pressure provided from the air supply unit 112 to the solenoid valve 110 through the air line 116.

When the computer 104 transmits an “ON” signal to the solenoid valve 110, the solenoid valve 110 may be opened. The opening of the solenoid valve 110 may cause the air supplied from the air supply unit 112 to flow through the solenoid valve 110 towards the air pressure valve 118. Furthermore, at this time, the pneumatic switch 114 may be placed in the “ON” state. A mechanical signal including information about the operating state of the pneumatic switch 114 may be converted into an electrical signal 146. The electrical signal 146 may be transmitted to the system control unit 102, particularly the PLC 106.

When the computer 104 transmits an “OFF” signal to the solenoid valve 110, the solenoid valve 110 may be closed. Therefore, the air supply through the solenoid valve 110 may be blocked. Here, the pneumatic switch 114 may be in the “OFF” state. Information of this state may be converted into the electrical signal 146 may be transmitted to the PLC 106.

The PLC 106 may compare the control signal 140 provided to the solenoid valve 110 with the electrical signal 146 outputted from the pneumatic switch 114. Based on this comparison, the PLC 106 may issue a warning signal to the computer 104. For example, air may leak through the air line 116 before flowing through the solenoid valve 110. This leakage may prevent enough air from flowing through the solenoid valve 110. Because enough air may not pass through the solenoid valve 110, the pneumatic switch 114 may indicate that the solenoid valve 110 is in the OFF state by transmitting an electrical “OFF” signal to the PLC 106. That is, the electrical OFF signal from the pneumatic switch 114 may indicate a certain air pressure being supplied to the solenoid valve 110. Meanwhile, the computer 104 may have provided the “ON” signal to the solenoid valve 110. This “ON” signal may have a corresponding reference air pressure associated with it.

Therefore, when the air pressure supplied into the solenoid valve 110 is different than a predetermined reference pressure set in the control panel 108, the PLC 106 may transmit a warning signal to the computer 104. The computer 104 may receive the warning signal from the PLC 106 and take corrective action to fix the problem associated with the air pressure difference.

Thus, when problems such as, for example, a malfunctioning air pressure valve 118, a defective solenoid valve 110, and a leakage in the air lines 116 occur in the air pressure valve system 100, the PLC 106 may output a warning signal to the computer 104. This warning signal may cause the computer 104 to modify the operation of the air pressure valve system 100. Specifically, in response to a warning signal, the computer 104 may suspend certain operations of the air pressure valve system 100. For example, operations of defective parts may be suspended upon receipt of a corresponding warning signal.

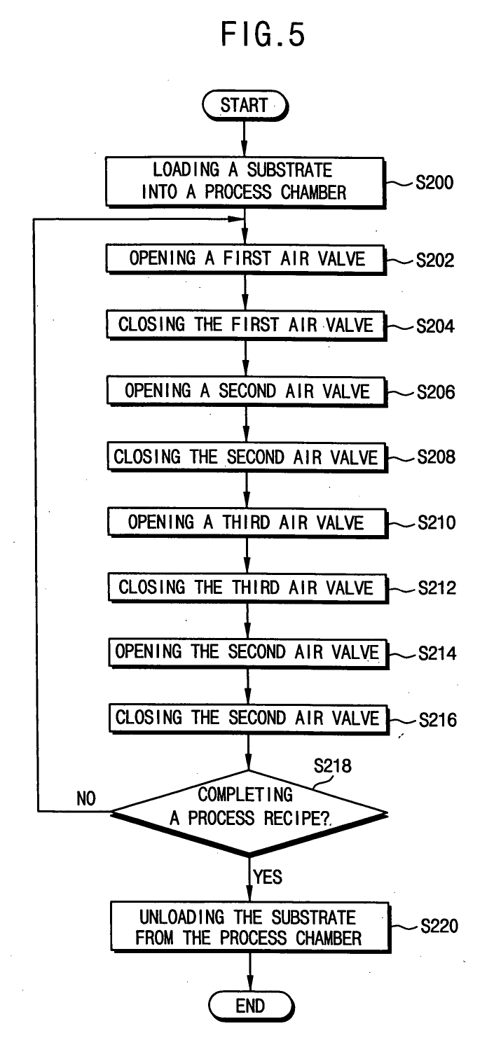

FIG. 5 is a flow chart illustrating the operations for controlling valves in an ALD process according to an exemplary disclosed embodiment.

Referring to FIGS. 2 and 5, at step S200, the semiconductor substrate may be loaded into the process chamber 124. The substrate may be positioned at a suitable location in the process chamber 124. In an exemplary embodiment, the process chamber 124 may include a single-type chamber in which the ALD process is carried out on a single semiconductor substrate. Alternatively, the process chamber 124 may include a batch-type chamber in which the ALD process is simultaneously carried out on, for example, 25 semiconductor substrates.

At step S202, the computer 104 may output the control signal 140 to the solenoid valve 110 for opening a first air pressure valve that is connected to a first gas supply unit. Furthermore, the computer 104 may also transmit the control signal 140 to the PLC 106. The first air pressure valve may respond to the control signal 140 by opening up. Thus, a first process gas is introduced into the process chamber 124 to form a first thin layer on the semiconductor substrate. In an exemplary embodiment, the first air pressure valve may be opened for about 1 second. The first detection unit on the first air pressure valve may convert information pertaining to the open state of the first air pressure valve, i.e., “ON” state, of the first air pressure valve into the electrical signal 142. Furthermore, the first detection unit outputs the electrical signal 142 to the PLC 106.

At step S204, the computer 104 may output the control signal 140 for closing the first air pressure valve to the solenoid valve 110 and the PLC 106. The first air pressure valve may respond to the control signal by closing itself. Furthermore, the first detection unit on the first air pressure valve may convert information pertaining to the closed state of the first air pressure valve, i.e., “OFF” state, of the first air pressure valve into the electrical signal 142. The first detection unit may also output the electrical signal 142 to the PLC 106.

The PLC 106 may compare a calculated open duration of the first air pressure valve in accordance with the control signal 140 with an actual open duration of the first air pressure valve in accordance with the electrical signal 142. If the difference between the actual open duration and the calculated open duration is greater than a reference value, the PLC 106 may transmit a warning signal to the computer 104. Upon receipt of the warning signal, the computer 104 may immediately suspend the operations of parts of the air pressure valve system 100 that are related to the first air pressure valve.

At step S206, the computer 104 may simultaneously open a second air pressure valve along with the closing of the first air pressure valve. The second air pressure valve may be connected to a purge gas supply unit that contains a purge gas such as, for example, an argon gas. Thus, the purge gas may be introduced into the process chamber 124 through the open second air pressure valve for a certain time period. At this time, a second detection unit on the second air pressure valve may convert information of the open state of the second air pressure valve into the electrical signal 142. The second detection unit may output the electrical signal 142 to the PLC 106.

At step S208, the computer 104 may close the second air pressure valve to stop the purge process. The second detection unit on the second air pressure valve may detect the closed state of the second air pressure valve and convert the information pertaining to the closed state of the second air pressure valve into the electrical signal 142. The second detection unit may then output the electrical signal 142 to the PLC 106. The PLC 106 may compare a calculated open duration of the second air pressure valve in accordance with the control signal 140 with an actual open duration of the second air pressure valve in accordance with the electrical signal 142 from the second detection unit. If the difference between the actual open duration and the calculated open duration is greater than a reference value, the PLC 106 may transmit a warning signal to the computer 104. Upon receipt of the warning signal, the computer 104 may immediately suspend the operations of parts of the air pressure valve system 100 that are related to the second air pressure valve.

At step S210, the computer 104 may output the control signal 140 to the solenoid valve 110 for opening a third air pressure valve that is connected to a third gas supply unit. Furthermore, the computer 104 may also transmit the control signal 140 to the PLC 106. The third air pressure valve may respond to the control signal 140 by opening up. Thus, a second process gas may be introduced into the process chamber 124 to form a second thin layer on the semiconductor substrate. In an exemplary embodiment, the third air pressure valve may be opened for about 1 second. Simultaneously, the third detection unit on the third air pressure valve may convert information pertaining to the open state of the third air pressure valve into the electrical signal 142. The third detection unit may output the electrical signal 142 to the PLC 106.

At step S212 the computer 104 may output the control signal 140 for closing the third air pressure valve to the solenoid valve 110 and the PLC 106. The third air pressure valve may respond to the control signal by closing itself. Furthermore, the third detection unit on the third air pressure valve may convert information pertaining to the closed state of the first air pressure valve, i.e., “OFF” state, of the first air pressure valve into the electrical signal 142. The third detection unit may also output the electrical signal 142 to the PLC 106.

The PLC 106 may compare a calculated open duration of the third air pressure valve in accordance with the control signal 140 with an actual open duration of the third air pressure valve in accordance with the electrical signal 142. If the difference between the actual open duration and the calculated open duration is greater than a reference value, the PLC 106 may transmit a warning signal to the computer 104. Upon receipt of the warning signal, the computer 104 may immediately suspend the operations of parts of the air pressure valve system 100 that are related to the third air pressure valve.

At step S214, the computer 104 may simultaneously open the second air pressure valve along with the closing the third air pressure valve. Thus, the purge gas may be introduced into the process chamber 124 through the open second air pressure valve for a second time. At this time, the second detection unit on the second air pressure valve may convert information of the open state of the second air pressure valve into the electrical signal 142. The second detection unit may output the electrical signal 142 to the PLC 106.

At step S216, the computer 104 may close the second air pressure valve to stop the purge process. The second detection unit on the second air pressure valve may detect the closed state of the second air pressure valve and convert the information pertaining to the closed state of the second air pressure valve into the electrical signal 142. The second detection unit may then output the electrical signal 142 to the PLC 106. The PLC 106 may compare a calculated open duration of the second air pressure valve in accordance with the control signal 140 with an actual open duration of the second air pressure valve in accordance with the electrical signal 142 from the second detection unit. If the difference between the actual open duration and the calculated open duration is greater than a reference value, the PLC 106 may transmit a warning signal to the computer 104. Upon receipt of the warning signal; the computer 104 may immediately suspend the operations of parts of the air pressure valve system 100 that are related to the second air pressure valve.

At step S218, the cycle of introducing the first process gas, the purge gas, the second process gas, and the purge gas is repeated several times until a process recipe is completed.

At step S220, the semiconductor substrate on which a thin layer having a desired thickness is formed, is unloaded from the process chamber 124.

The disclosed air pressure valve system 100 may be used in any system used for carrying out an ALD process. As described above, a detection unit 126 on the air pressure valve 118 may recognize whether the air pressure valve 118 is open or not. The detection signal 142 of the detection unit 126 may then be transmitted to the system control unit 102. The system control unit 102 may compare the calculated open duration of the air pressure valve 118 in accordance with the control signal 140 with the actual open duration of the air pressure valve 118 in accordance with the detection signal 142 to immediately recognize malfunctions and failures of the air pressure valve 118. Thus, when parts in the air pressure valve system 100 malfunction, the operations of those parts may be suspended. The suspension of operation of malfunctioning parts in the system may prevent the manufacture of defective products. Furthermore, the number of accidents occurring during the ALD process may also be reduced by use of the disclosed system.

Having described the preferred embodiments of the present invention, it is noted that modifications and variations can be made by persons skilled in the art in light of the above teachings. It is, therefore, to be understood that changes may be made in the particular embodiment of the present invention disclosed which is within the scope and the spirit of the invention outlined by the appended claims.

What is claimed is:

1. A valve system, comprising:
a system-control unit which generates a control signal;
a solenoid valve which supplies air pressure in response to the control signal generated by the system-control unit;
a gas line which supplies a process gas;
an air pressure valve which opens and closes in response to the air pressure supplied by the solenoid valve to selectively supply the process gas from the gas line; and
a detection unit installed in the air pressure valve which generates a detection signal indicative of at least one of an opened and closed state of the air pressure valve,
wherein the detection signal generated from the detection unit is transmitted to the system control unit, and wherein the system control unit compares a calculated open duration of the air pressure valve in accordance with the control signal with an actual open duration of the air pressure valve in accordance with the detection signal.

2. The air pressure valve system of claim 1, wherein the system control unit comprises:
a computer which outputs the control signal to the solenoid valve; and
a programmable logic controller (PLC) which receives the control signal from the computer and the detection signal from the detection unit,
wherein the PLC compares the calculated open duration of the air pressure valve in accordance with the control signal with the actual open duration of the air pressure valve in accordance with the detection signal, and transmits a warning signal to the computer when an actual open duration of the air pressure valve exceeds a predetermined reference value.

3. The valve system of claim 2, wherein the reference value comprises an allowable error range with respect to a difference between the calculated open duration and the actual open duration.

4. The valve system of claim 2, wherein the system control unit further comprises a control panel electrically connected to the PLC, the reference value being inputted into the control panel.

5. The valve system of claim 1, wherein the detection unit includes at least one of a micro switch and a photo-proximity sensor.

6. The valve system of claim 1, further comprising a pneumatic switch which senses a pressure of an air supply to the solenoid valve and which transmits the sensed air pressure to the system control unit.

7. The valve system of claim 1, wherein the air pressure valve comprises:
a sealed space connected to the gas line;
an air inlet;
an actuator which moves vertically in the sealed space; and
a diaphragm arranged under the actuator, wherein the diaphragm regulates a gas flow through the gas line.

8. The valve system of claim 7, wherein the detection unit is mounted on the actuator to detect whether the air pressure valve is open or closed based on a position of the actuator.

9. A deposition apparatus comprising:
an Atomic Layer Deposition (ALD) chamber;
a system-control unit which generates a control signal;
a solenoid valve which supplies air pressure in response to the control signal generated by the system-control unit;
a gas line which supplies a process gas;
an air pressure valve which opens and closes in response to the air pressure supplied by the solenoid valve to selectively supply the process gas from the gas line for the ALD chamber; and
a detection unit installed in the air pressure valve which generates a detection signal indicative of at least one of an opened and closed state of the air pressure valve,
wherein the detection signal generated from the detection unit is transmitted to the system control unit, and wherein the system control unit compares a calculated open duration of the air pressure valve in accordance with the control signal with an actual open duration of the air pressure valve in accordance with the detection signal.

10. The apparatus of claim 9, wherein the system control unit comprises:
a computer which outputs the control signal to the solenoid valve; and
a programmable logic controller (PLC) which receives the control signal from the computer and the detection signal from the detection unit,
wherein the PLC compares the calculated open duration of the air pressure valve in accordance with the control signal with the actual open duration of the air pressure valve in accordance with the detection signal, and transmits a warning signal to the computer when an actual open duration of the air pressure valve exceeds a predetermined reference value.

11. The apparatus of claim 10, wherein the reference value comprises an allowable error range with respect to a difference between the calculated open duration and the actual open duration.

12. The apparatus of claim 10, wherein the system control unit further comprises a control panel electrically connected to the PLC, the reference value being inputted into the control panel.

13. The apparatus of claim 9, wherein the detection unit includes at least one of a micro switch and a photo-proximity sensor.

14. The apparatus of claim 9, further comprising a pneumatic switch which senses a pressure of an air supply to the solenoid valve and which transmits the sensed air pressure to the system control unit.

15. The apparatus of claim 9, wherein the air pressure valve comprises:
a sealed space connected to the gas line;
an air inlet;
an actuator which moves vertically in the sealed space; and
a diaphragm arranged under the actuator, wherein the diaphragm regulates a gas flow through the gas line.

16. The apparatus of claim 15, wherein the detection unit is mounted on the actuator to detect whether the air pressure valve is open or closed based on a position of the actuator.
